(19) United States
(12) Patent Application Publication
(10) Pub. No.: US 2015/0262187 A1
(43) Pub. Date: Sep. 17, 2015

(54) METHOD FOR DOING BUSINESS

(71) Applicant: Juichin Lee, Taipei City (TW)

(72) Inventor: Juichin Lee, Taipei City (TW)

(21) Appl. No.: 14/207,766

(22) Filed: Mar. 13, 2014

(51) Int. Cl. G06Q 30/00; G06Q 30/06

(52) U.S. Cl. CPC G06Q 30/012; G06Q 30/0623

(57) ABSTRACT

A method for doing business with barcodes is disclosed, The method includes the steps of: a) creating a barcode system having a one-dimensional (1D) barcode and a two-dimensional (2D) barcode corresponding to the 1D barcode, wherein the two barcodes reflect a single product made by a manufacture; b) using the 2D barcode to browse a website of the product by a customer; c) using the 1D barcode to make checkout by a dealer; d) after the step c), the customer using the 2D barcode to activate a registration, service and warranty; and e) using the 2D barcode to inform the customer a message about the product by the manufacture.

### BACKGROUND OF THE INVENTION

1. Technical Field

The invention relates to a business model, particularly to a business model with networks and barcodes.

2. Related Art

A barcode is an optical machine-readable representation of data relating to the object to which it is attached. Originally barcodes systematically represented data by varying the widths and spacings of parallel lines, and may be referred to as linear or one-dimensional (1D). A typical 1D barcode is shown in FIG. 1. Later they evolved into rectangles, dots, hexagons and other geometric patterns in two dimensions (2D). Although 2D systems use a variety of symbols, they are generally referred to as barcodes as well. Barcodes originally were scanned by special optical scanners called barcode readers. Later, scanners and interpretive software became available on devices including desktop printers and smartphones.

Barcodes became commercially successful when they were used to automate supermarket checkout systems, a task for which they have become almost universal. Their use has spread to many other tasks that are generically referred to as automatic identification and data capture (AIDC).

Some 2D barcodes embed a hyperlink to a web page. A capable cellphone might be used to read the pattern and browse the linked website, which can help a shopper find the best price for an item in the vicinity.

QR code (abbreviated from Quick Response Code) is a type of 2D barcode. A QR code, as shown in FIG. 2, uses four standardized encoding modes (numeric, alphanumeric, byte/binary, and kanji) to efficiently store data; extensions may also be used.

The QR Code system has become popular due to its fast readability and greater storage capacity compared to standard 1D UPC (Universal Product Code) barcodes. Applications include product tracking, item identification, time tracking, document management, general marketing, and much more.

A 2D barcode can carry much more data than a 1D barcode, but most dealers or shops still use POS (point of sale) systems based on 1D barcode. On the other hand, QR code has been extensively used by smartphone and tablet computer users to hyperlink a website. Currently, there is no barcode system which can simultaneously provide these two functions (checkout and hyperlink) in the market.

### SUMMARY OF THE INVENTION

An object of the invention is to provide a method for doing business, which can simultaneously provide two functions of checkout and hyperlink by means of 1D and 2D barcodes.

To accomplish the above object, the method of the invention includes the steps of: a) creating a barcode system having a one-dimensional (1D) barcode and a two-dimensional (2D) barcode corresponding to the 1D barcode, wherein the two barcodes reflect a single product made by a manufacture; b) using the 2D barcode to browse a website of the product by a customer; c) using the 1D barcode to make checkout by a dealer; d) after the step c), the customer using the 2D barcode to activate a registration, service and warranty; and e) using the 2D barcode to inform the customer a message about the product by the manufacture.

### BRIEF DESCRIPTION OF THE DRAWINGS

FIG. 1 shows an exemplary 1D barcode;

FIG. 2 shows an exemplary 2D barcode;

FIG. 3 is a flowchart of the method for doing business of the invention;

FIG. 4 is a flowchart of the method for performing online shopping with wireless calling of the invention when a dealer does not have a POS system; and

FIG. 5 is a flowchart of the method for performing online shopping with wireless calling of the invention when a dealer has a POS system.

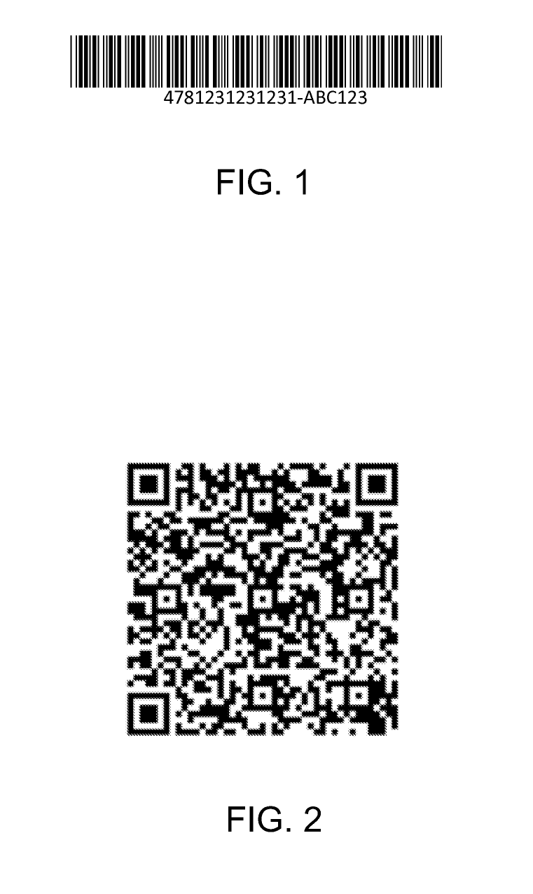

### DETAILED DESCRIPTION OF THE INVENTION

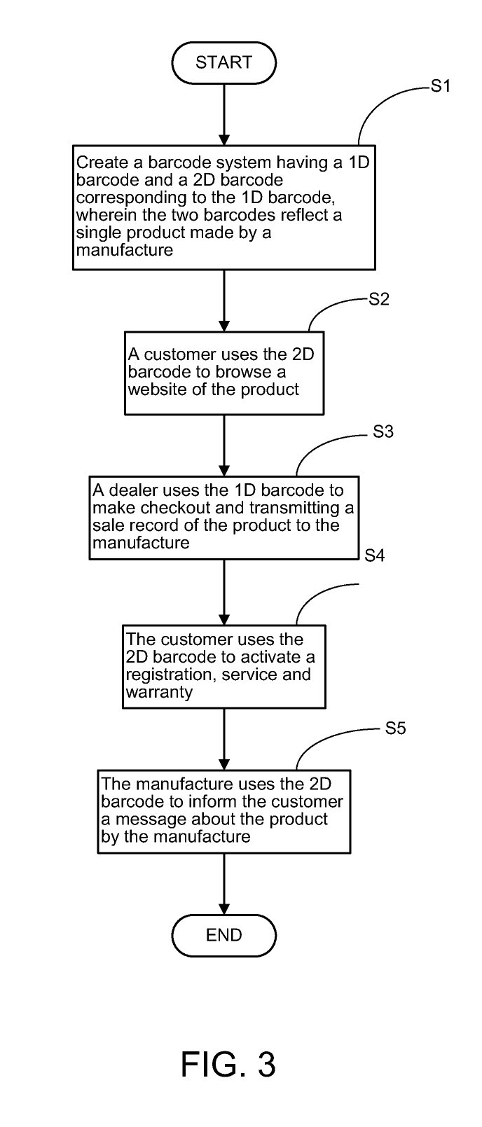

Please refer to FIG. 3, which shows a flowchart of the method for doing business. In step S1, a barcode system is created. The barcode system has one-dimensional (1D) barcodes and two-dimensional (2D) barcodes separately corresponding to the 1D barcodes. That is to say, a 1D barcode and 2D barcode compose a couple of barcodes. And a couple of barcodes reflect a single product made by a manufacture. In detail, there is a tag with a 1D barcode and 1 2D barcode which are a couple, and the tag is adhered or attached on a product. The 1D barcode is a product code such as a Universal Product Code (UPC). The 2D barcode may be a QR code representing a website address for hyperlinking.

When the product has been exhibited in a dealer, in step S2, a customer uses the 2D barcode on the product to browse a website of the product for obtaining more information of the product if he or she is interested in the product. The customer may use a smartphone or tablet to scan the QR code to hyperlink the website of the product.

When the customer has decided to buy the product, in step S3, the dealer uses the 1D barcode to make checkout. Meanwhile the sale record will be stored in and transmitted to a server of the manufacture. As a result, the manufacture can know when and where the product was sold.

After the step S3, the customer uses the 2D barcode to activate a registration, service and warranty in step S4. Every product is provided with a unique 2D barcode, so a customer can use the 2D barcode to activate various after-sale services, such as warranty condition and expiration date.

After the step S4, the manufacture may use the 2D barcode to inform the customer a message about the product in step S5. In the step S4, the customer uses the 2D barcode to hyperlink the website of the product, so the manufacture can use the 2D barcode to send a message to the customer.

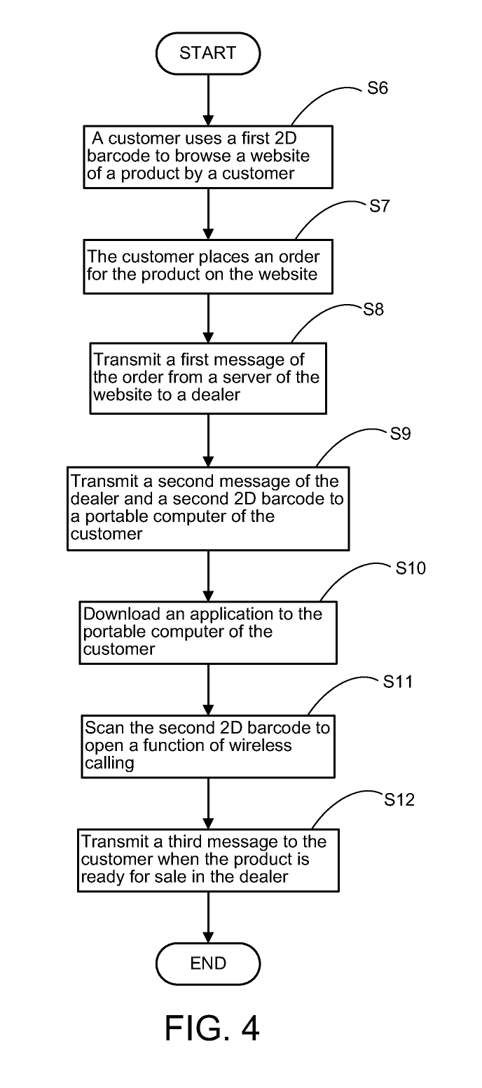

The invention further provides a method for performing online shopping with wireless calling. The method is used for pre-orders. An object of the method is to prevent customers from waiting for products to be bought because customers will be immediately informed of being ready of the product. When the method is applied in a dealer without a POS (point of sale) system, the method includes the following steps as shown in FIG. 4:

In step S6, a customer uses a first 2D barcode to browse a website of a product when he or she is interested in the product. The first 2D barcode is printed on a sample of the product, show card or print media such as magazine and advertising light box.

In step S7, the customer places an order for the product on the website when he or she decides to buy the product.

In step S8, transmit a first message of the order from a server of the website to a dealer through a network. As a result, the dealer can be aware of the order.

In step S9, transmit a second message of the dealer and a second 2D barcode to a portable computer of the customer. The portable computer may be a smartphone or tablet computer.

In step S10, download an application to the portable computer of the customer;

In step S11, the customer uses the application to scan the second 2D barcode to open a function of wireless calling.

In step S12, transmit a third message to the customer when the product is ready for sale in the dealer.

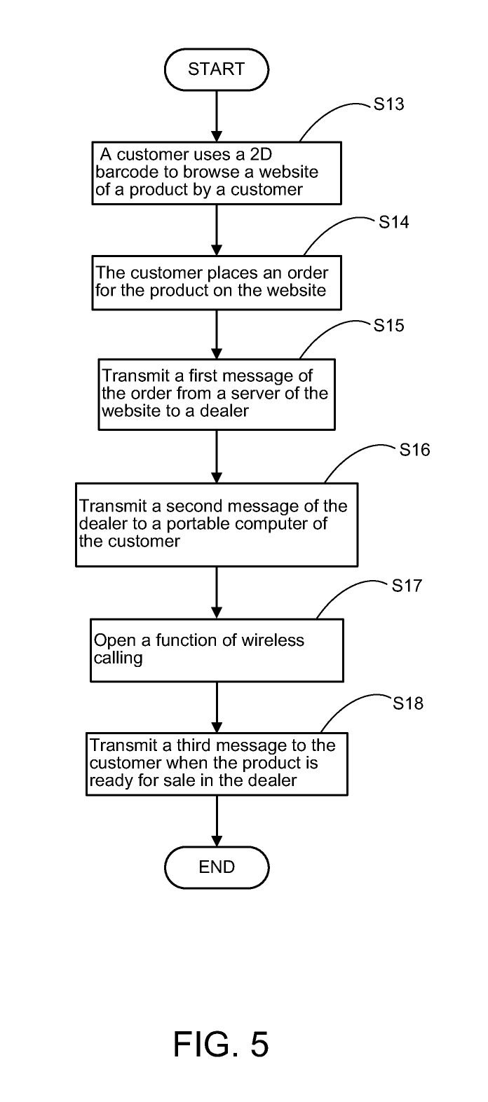

When the method is applied in a dealer with a POS (point of sale) system, the method includes the following steps as shown in FIG. 5:

In step S13, a customer uses a 2D barcode to browse a website of a product when he or she is interested in the product.

In step S14, the customer places an order for the product on the website when he or she decides to buy the product.

In step S15, transmit a first message of the order from a server of the website to a dealer through a network. As a result, the dealer can be aware of the order.

In step S16, transmit a second message of the dealer to a portable computer of the customer. The portable computer may be a smartphone or tablet computer.

In step S17, open a function of wireless calling.

In step S18, transmit a third message to the customer when the product is ready for sale in the dealer.

It will be appreciated by persons skilled in the art that the above embodiment has been described by way of example only and not in any limitative sense, and that various alterations and modifications are possible without departure from the scope of the invention as defined by the appended claims.

What is claimed is:

1. A method for doing business, comprising the steps of:
a) creating a barcode system having a one-dimensional (1D) barcode and a two-dimensional (2D) barcode corresponding to the 1D barcode, wherein the two barcodes reflect a single product made by a manufacture;
b) using the 2D barcode to browse a website of the product by a customer;
c) using the 1D barcode to make checkout by a dealer and transmitting a sale record of the product to the manufacture;
d) after the step c), the customer using the 2D barcode to activate a registration, service and warranty; and
e) using the 2D barcode to inform the customer a message about the product by the manufacture.

2. A method for performing online shopping with wireless calling, comprising:
a) using a first 2D barcode to browse a website of a product by a customer;
b) placing an order for the product on the website;
c) transmitting a first message of the order from a server of the website to a dealer;
d) transmitting a second message of the dealer and a second 2D barcode to a portable computer of the customer;
e) downloading an application to the portable computer of the customer;
f) scanning the second 2D barcode to open a function of wireless calling; and
g) transmitting a third message to the customer when the product is ready for sale in the dealer.

3. A method for performing online shopping with wireless calling, comprising the steps of:
a) using a 2D barcode to browse a website of a product by a customer;
b) placing an order for the product on the website;
c) transmitting a first message of the order from a server of the website to a dealer;
d) transmitting a second message of the dealer to a portable computer of the customer;
e) opening a function of wireless calling; and
f) transmitting a third message to the customer when the product is ready for sale in the dealer.
